(19) United States
(12) Patent Application Publication
(10) Pub. No.: US 2009/0236538 A1
(43) Pub. Date: Sep. 24, 2009

(54) MOBILE RADIATION THREAT IDENTIFICATION SYSTEM

(75) Inventor: David L. Frank, Boca Raton, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Coconut Creek, FL (US)

(21) Appl. No.: 12/409,733

(22) Filed: Mar. 24, 2009

Related U.S. Application Data
(60) Provisional application No. 61/070,590, filed on Mar. 24, 2008.
(60) Provisional application No. 61/128,114, filed on May 19, 2008.
(60) Provisional application No. 61/128,115, filed on May 19, 2008.

(51) Int. Cl. G01J 1/42; G06F 17/18

(52) U.S. Cl. 250/394; 702/180

(57) ABSTRACT

A system, method, and mobile vehicle, identify materials associated with radiation that has been detected. A set of radiation data associated with radiation from at least one radiation source is received from a set of radiation sensors mechanically coupled to the mobile vehicle. At least one histogram is generated based on the set of radiation data. The at least one histogram represents a spectral image of radiation from the radiation source. The at least one histogram is compared to multiple spectral images associated with known materials. The at least one histogram is determined to substantially match at least one of the multiple spectral images. A determination is made as to whether the material is a hazardous material. Personnel are notified that the at least one radiation source is a hazardous material in response to determining that the material associated with the at least one of the multiple spectral images is a hazardous material.

### CROSS-REFERENCE TO RELATED APPLICATIONS

This application is based on and claims priority to co-pending provisional U.S. Patent Application No. 61/070,590, entitled “Marine and Vehicle Mobile Radiation Threat Identification System”, filed on Mar. 24, 2008, by the same inventor, and to co-pending provisional U.S. Patent Application No. 61/128,114, entitled “Radiation Directional Finder and Isotope Identification System”, filed on May 19, 2008, by the same inventor, and to co-pending provisional U.S. Patent Application No. 61/128,115, entitled “Mobile Frame Structure With Passive/Active Sensor Arrays For Non-Invasive Analysis For CBRNE Materials Present”, filed on May 19, 2008, by the same inventor, and to co-pending provisional U.S. Patent Application No. 61/______, entitled “Method For Increased Gamma/Neutron Detector Performance”, filed on Feb. 25, 2009, by the same inventor, and to co-pending provisional U.S. Patent Application No. 61/______, entitled “Method For Increased Gamma/Neutron Detector Performance, version 2”, filed on Mar. 13, 2009, by the same inventor, and to co-pending provisional U.S. Patent Application No. 61/______, entitled “High Performance Neutron Detector With Near Zero Gamma Cross Talk”, filed on Mar. 4, 2009, by the same inventor, and to co-pending provisional U.S. Patent Application No. 61/______, entitled “High Performance Neutron Detector With Near Zero Gamma Cross Talk, version 2”, filed on Mar. 13, 2009, by the same inventor; the entire collective teachings of which being incorporated herein by reference.

### FIELD OF THE INVENTION

The present invention generally relates to the field of hazardous material detection, and more particularly relates to a mobile system for detecting and identifying hazardous materials.

### BACKGROUND OF THE INVENTION

Current radiation portals used in security applications for inspecting vehicles and cargo are configured as fixed assets that cannot be easily re-assigned or used as a mobile analysis platform. Many of the current radiation detection devices are handheld radiation devices that need to be placed in very close proximity to the target for analysis. This can potentially place the operator of the device in dangerous and/or hazardous conditions. Also, most hand held radiation devices can only cover a small area at one time.

Therefore a need exists to overcome these problems as discussed above.

### SUMMARY OF THE INVENTION

In one embodiment, a method identifies materials associated with radiation that has been detected. The method includes receiving a set of radiation data associated with at least one radiation source from a set of radiation sensors mechanically coupled to a mobile vehicle. At least one histogram is generated based on the set of radiation data. The at least one histogram represents a spectral image of the radiation source. At least one histogram is compared to multiple spectral images associated with known materials. The at least one histogram is determined to substantially match at least one of the multiple spectral images. A determination is made as to whether the material associated with the at least one of the multiple spectral images is a hazardous material. Personnel are notified that the at least one radiation source is a hazardous material in response to determining that the material associated with the at least one of the multiple spectral images is a hazardous material.

In another embodiment, a mobile vehicle is suitable for detecting radiation and identifying materials associated with radiation that has been detected. The mobile vehicle includes at least one set of radiation sensors mechanically coupled to a portion of the mobile vehicle. At least one information processing system is communicatively coupled to the set of radiation sensors. The information processing system is adapted to receive a set of radiation data associated with at least one radiation source from a set of radiation sensors mechanically coupled to the mobile vehicle. At least one histogram is generated based on the set of radiation data. The at least one histogram represents a spectral image of the radiation source. At least one histogram is compared to multiple spectral images associated with known materials. The at least one histogram is determined to substantially match at least one of the multiple spectral images. A determination is made as to whether the material associated with the at least one of the multiple spectral images is a hazardous material. Personnel are notified that the at least one radiation source is a hazardous material in response to determining that the material associated with the at least one of the multiple spectral images is associated with a hazardous material.

In yet another embodiment, a system is suitable for detecting radiation and identifying materials associated with radiation that has been detected. The system includes at least one mobile vehicle including at least one set of radiation sensors that are mechanically coupled to a portion of the mobile vehicle. At least one information processing system is communicatively coupled to the at least one mobile vehicle. The information processing system is adapted to receive a set of radiation data associated with at least one radiation source from a set of radiation sensors mechanically coupled to the mobile vehicle. At least one histogram is generated based on the set of radiation data. The at least one histogram represents a spectral image of the radiation source. At least one histogram is compared to multiple spectral images associated with known materials. The at least one histogram is determined to substantially match at least one of the multiple spectral images. A determination is made as to whether the material associated with the at least one of the multiple spectral images is a hazardous material. Personnel are notified that the at least one radiation source is a hazardous material in response to determining that the material associated with the at least one of the multiple spectral images is a hazardous material.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a general overview of an operating environment according to one embodiment of the present invention;

FIG. 2. is a schematic view of a directional detector set for determining the direction of a radiation source according to one embodiment of the present invention;

FIGS. 3-4 show two examples of a mobile environment for detecting radiation and identifying the source of the radiation that has been detected according to various embodiments of the present invention;

FIG. 5 is an operational flow diagram illustrating one process of detecting radiation and identifying hazardous materials associated with the radiation using a mobile environment according to one embodiment of the present invention; and

FIG. 6 is a block diagram illustrating a detailed view of an example of an information processing system suitable for use in an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

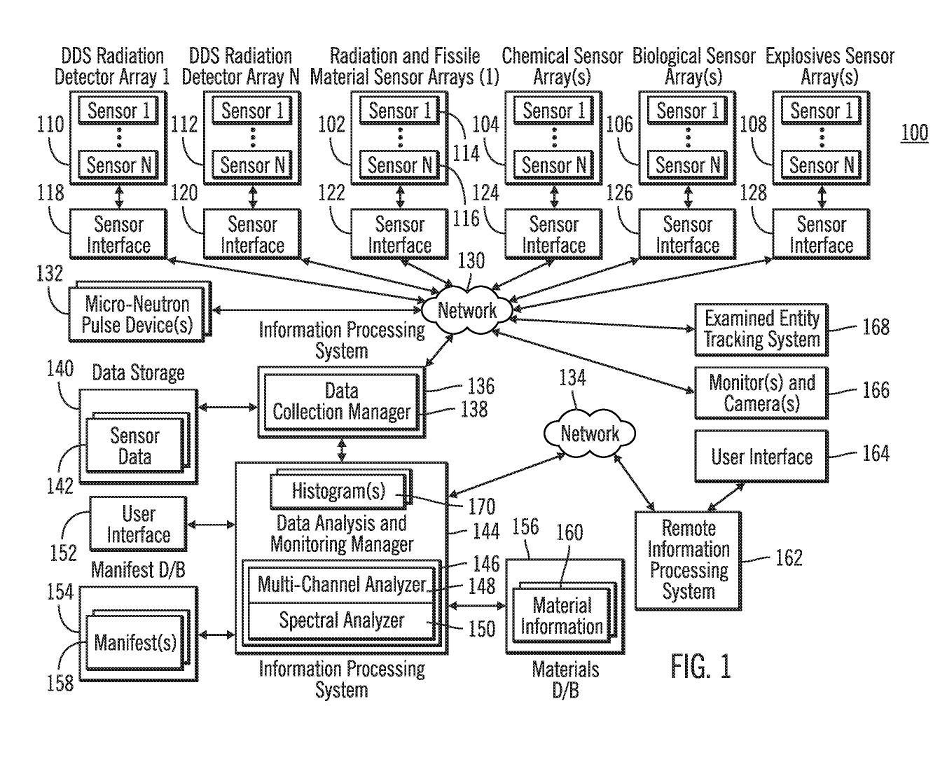

According to one embodiment of the present invention as shown in FIG. 1 a general view of an operating environment 100 is illustrated. In one embodiment, all or part of the operating environment 100 is implemented within a mobile environment such as a ground vehicle (e.g., car/truck), water vehicle (e.g., boat), and/or an air vehicle (e.g., helicopter or a drone), or a combination thereof (e.g., an amphibious vehicle or a plane with water landing pontoon) for enabling the detection, analysis, and identification of hazardous materials such as CBRNE materials. In other words, the operating environment 100 enables mobile non-invasive analysis of vessels, vehicles, containers, buildings, seaports, waterways, borders, metropolitan areas, strategic areas, and the like, for the detection and identification of hazardous materials such as radiological materials, fissile materials, explosives, chemicals, and biological materials. Various sensor systems within a mobile environment are able to analyze a slow moving or stopped vehicle, container, package, or cargo in a non-invasive approach.

In particular, FIG. 1 shows one or more sensor arrays 102, 104, 106, 108, 110, 112 that each including a plurality of sensors 114, 116. One or more of these sensors, in one embodiment, are shielded from electro-magnetic-interference (“EMI”), but this is not required. In one embodiment, the sensors 114, 116 of the sensor arrays 102, 104, 106, 108, 110, 112 comprise gamma radiation sensors and/or neutron sensors. Each of the sensor arrays 102, 104, 106, 108, 110, 112 can include a combination of gamma and neutron sensing devices. Examples of radiation detectors are cadmium zinc telluride detectors, sodium iodide detectors, and the like. Neutron detectors can be solid-state neutron detectors, which provide shock resistance. Also, to assist in the detection of radiation at distances, the gamma detectors may be equipped with collimators and/or lenses that gather the radiological particles and focus these particles onto the detectors. Shock resistance detectors are suitable for verifying radiation from objects that can move and cause shock/vibration hazards to the sensors. FIG. 1 shows that one or more sensor arrays 102, 104, 106, 108, are radiation/fissile material sensor arrays, chemical sensor arrays, biological sensor arrays, and/or explosive sensor arrays.

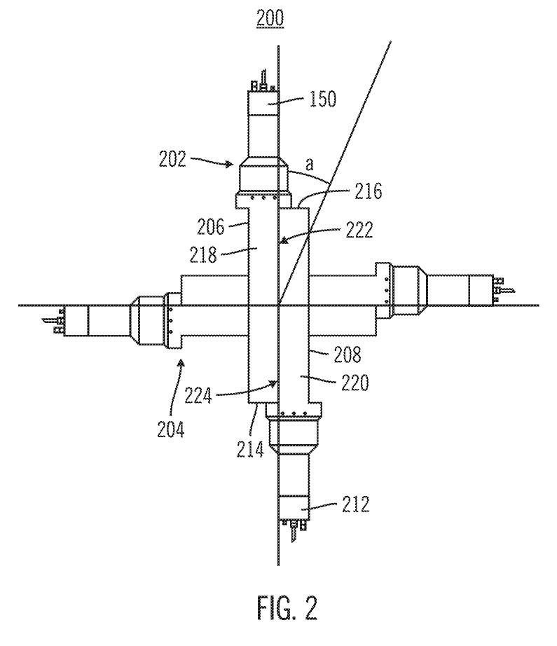

In addition to the radiation/fissile material, chemical, biological, and explosive sensor arrays, sensory directional detection sensors (“DDS”) arrays 110, 112, can be included within the environment 100 as well. DDS arrays are used to identify the direction of a radiation emitting source. For example, FIG. 2 shows two sensor sets 202, 204 coupled together to form a 360 degree DDS detector set 200. In one embodiment, a DDS detector set 202 includes a first sensor 206 and a second sensor 208. As discussed above, these sensors 206, 208 can be radiation sensors such as gamma ray sensors and/or neutron detectors. Each sensor 206, 208, includes a first end 210, 212, a second end 214, 216, and a body 218, 220, situated between the first end 210, 212 and the respective second end 214, 216.

A first portion 222 of the first sensor body 218 is coupled to a first portion 224 of the second sensor body 220 creating a back-to-back configuration as shown in FIG. 2. In other words, the first sensor body 218 is coupled to the first portion 224 of the second sensor body 220 so that the body portions 218, 220 are adjacent to each other. According to one embodiment, the sensing portion of the first radiation sensor and a sensing portion of the second radiation sensor are adjacent in close proximity with each other. For example, one sensor 206 could be a gamma sensor while the other sensor 208 could be a neutron sensor. Alternatively, both sensors may be gamma sensors. Both sensors 206, 208 are oriented back-to-back. In one embodiment, the first sensor set 202 and the second sensor set 204 are similarly configured with two back-to-back sensors. The two back-to-back sensors are situated perpendicular to each other thereby creating substantially 90 degree angles between the sensor sets 202, 204. It should be noted that FIG. 2 shows only one configuration that may be applicable to the present invention, and other configurations apply as well.

Configuring the sensors within the DDS sensor arrays so that the body portions 218, 220 are adjacent to each other allows this configuration to be in a mutual substantially shielding relationship between the two sensors 206, 208, and/or in a timing relationship for determining time of a particle traveling into each of the two back-to-back sensors. Stated differently, each first sensor may substantially shield the other second sensor from radiation being absorbed by the first sensor (e.g., a sensing portion of a first radiation sensor and a sensing portion of a second radiation sensor are adjacent in close proximity with each other and facing opposite directions), and/or each first sensor will sense a traveling particle (e.g., gamma or neutron particle) entering into the first sensor earlier in time than the second sensor sensing the particle entering the second sensor. Therefore, to determine the direction of the radiation source, the data analysis and monitoring manager 138 compares the energy counts at each sensor in a DDS sensor set, and/or the timing relationships between the energy counts between the back-to-back sensors, and identifies the sensor associated with the larger energy count relative to the sensor associated with the lower energy count, and/or the earlier time of entering the respective sensor. The direction that the sensor associated with the larger energy count, and/or the relative earlier time of entering a respective one of the two sensors, indicates the direction of the radiation source. The direction of the radiation source can be determined based on, for example, the larger energy count because only the sensor facing the direction of the source receives the larger amount of radiation energy since this sensor substantially shields the other sensor from receiving an equal amount of radiation from the source. The direction of the radiation source can also be determined based on the timing relationship of energy counts between the two back-to-back sensors (e.g., from a radiation sensor that has detected the later time to the other one that has detected the earlier time). A more detailed discussion on DDS arrays is given in provisional U.S. Patent Application No. 61/128,114, entitled “Radiation Directional Finder and Isotope Identification System”, filed on May 19, 2008, by the same inventor, and which is hereby incorporated by reference in its entirety.

Returning to FIG. 1, it should be noted that although FIG. 1 shows separate DDS arrays 110, 112, any of the other arrays 102, 104, 106, 108 can be configured to be a DDS array as well. Each sensor array 102, 104, 106, 108, 110, 112 is communicatively coupled to a sensor interface 118, 120, 122, 124, 126, 128 either by a wired and/or a wireless communication link. The sensor interfaces 118, 120, 122, 124, 126, 128 communicatively couple the sensor arrays 102, 104, 106, 108, 110, 112 to a first network 130, thereby creating a distributed sensor network. The first network 130 includes wired and/or wireless technologies and the sensor interface units 118, 120, 122, 124, 126, 128 are communicatively coupled to the first network 130 either wirelessly and/or via wired mechanisms. In one embodiment, the sensor interfaces 118, 120, 122, 124, 126, 128 assign a unique IP address to each of the sensors 114, 116 within the sensor arrays 102, 104, 106, 108, 110, 112.

The sensor interfaces 118, 120, 122, 124, 126, 128, in one embodiment, are sensor integration units (“SIU”) that provide the calibration, automated gain control, calibration verification, remote diagnostics, and connectivity to the processor for spectral analysis of the sensor data. SIUs are discussed in greater detail in U.S. Pat. No. 7,269,527 entitled “System Integration Module For CBRNE Sensors”, filed on Jan. 17, 2007, which is commonly owned and is hereby incorporated by reference in its entirety. It should be noted that although FIG. 1 shows each of the sensor arrays 102, 104, 106, 108, 110, 112 coupled to a separate sensor interface 114, 116 a single sensor interface can be coupled to all of the sensor arrays 102, 104.

One or more micro-neutron pulse devices 132 are also optionally included within the operating environment 100 and are communicatively coupled to the first network 130 and/or a second network 134. A micro-neutron pulse device 132 is an active analysis device that emits neutron pulses and whereby gamma feedback identifies shielded radiological materials such as highly enriched uranium, explosives, illicit drugs, or other materials. The first and second networks 130, 134 can include any number of local area networks and/or wide area networks. It should be noted that even though FIG. 1 shows two networks 130, 134, a single network can be implemented or additional networks can be added.

The operating environment 100 also includes an information processing system 136 communicatively coupled to the first network 130 via one or more wired and/or wireless communication links. The information processing system 136 includes a data collection manager 138 and is communicatively coupled to one or more data storage units 140. The one or more storage units 140 can reside within the information processing system 136 and/or outside of the system 136 as shown in FIG. 1. The data collection manager 138 manages the collection and/or retrieval of data 142 generated by the sensors 114, 116 within the sensor arrays 102, 104, 106, 108, 110, 112 and optionally the micro-neutron pulse detector 132.

The data 142 generated by each of the sensors 114, 116, in one embodiment, is detailed spectral data from each sensor device that has detected radiation such as gamma radiation and/or neutron radiation. The data collection manager 138, in one embodiment, stores the data 142 received/retrieved from the sensor arrays 102, 104, 106, 108, 110, 112 and/or the neutron pulse detector 132 in one or more data storage devices 140. A data storage device 140 can be a single hard-drive, two or more coupled hard-drives, solid state memory devices, and/or optical media such as (but not limited to) compact discs and digital video discs, and the like. It should be noted that this list of storage devices is not exhaustive and any type of storage device can be used. It should also be noted that information processing system 136 including the data collection manager 138 is modular in design and can be used specifically for radiation detection and identification and/or for data collection for explosives and special materials detection and identification.

The operating environment 100, in one embodiment, also includes an information processing system 144 communicatively to the at least a second network 134 via one or more wireless and/or wired communication technologies. The information processing system 144, in one embodiment, includes a data analysis and monitoring manager 146 that analyzes and monitors the data 142 retrieved/received from the sensor arrays 102, 104, 106, 108, 110, 112 and optionally the micro-neutron pulse detector 132. The data analysis and monitoring manager 146, in one embodiment, includes a multi-channel analyzer 148 and a spectral analyzer 150. The data analysis and monitoring manager 146 and each of these components 148, 150 are discussed in greater detail below.

In one embodiment, a user interface 152, a manifest database 154, and a materials database 156 are communicatively coupled to the information processing system 144 either directly or via a network (e.g. the second network 134). The user interface 152, in one embodiment, is one or more displays, input devices, output devices and/or the like that allows a user to monitor and/or interact with the information processing system 144. The data and analysis functionality of the information processing system 144, which is discussed in greater detail below, can either be automated and/or supplemented with human interaction. The user interface(s) 152 enables this human interaction.

The manifest database 154 includes a plurality of manifests 158 associated with shipping cargo, which can be cargo on a water vessel, a ground vessel (e.g., cars, trucks, and/or trains), and/or an air transportation vessel. A manifest 160 includes a detailed description of the contents of each container or cargo that is to be examined by the sensor arrays 102, 104, 106, 108, 110, 112 and/or the neutron pulse device(s) 132. The manifests 158 are used by the information processing system 144 to determine whether the possible materials, goods, and/or products within the container package, car, truck, or the like, match the expected authorized materials, goods, and/or products, described in the manifest 158 for the particular entity under examination. The use of a manifest 158 during examination of an entity is discussed in greater detail below.

The materials database 156 includes materials information 160 such as chemical material information, biological material information, radioactive material information, nuclear material information, and/or explosive material information. Also, the materials information 160 can include isotope information for known isotopes. For example, isotope information can include spectral images, histograms, energy levels, and/or the like associated with known isotopes. The materials information 160, in one embodiment, is used by the data analysis and monitoring manager 146 to determine whether any hazardous materials are within an entity that is being examined. This identification/detection process is discussed in greater detail below.

It should be noted that although the manifest database 154 and the materials database 156 are shown in FIG. 1 as being separate from the information processing system 144, one or more of these databases 154, 156 can reside within the information processing system 144 as well. Furthermore, the components of the information processing system 136 and the information processing system 144 can be implemented within a single information processing system as compared to multiple systems as shown in FIG. 1.

The operating environment 100, in one embodiment, also includes a remote monitoring information processing system 162 communicatively coupled to the second network 134. A user interface 164, which can be one or more displays, input devices, output devices and/or the like that allows a user to monitor and/or interact with the remote system 162, is communicatively to the system 162. The remote monitoring system 162 includes a computer, memory, and storage, and enables a user to remotely monitor, manage, and/or control the remote information processing system 162 and/or the data analysis and monitoring processes being performed at the information processing system 144. Also, the remote monitoring system 162 can be a device such as a wireless communication device, portable computer, desktop and/or the like, that receives notifications from the information processing system 144 regarding the data analysis and monitoring processes.

In one embodiment, one or more monitors/camera systems 166 such as (but not limited to) a closed circuit television system is also included within the operating environment 100. The cameras within this system 166 can be deployed in a mobile environment such as a vehicle or at stationary portal communicatively coupled to a mobile environment. Therefore, an operator can monitor a scanning process occurring in the mobile environment and/or at a stationary portal. Also, an examined entity tracking system 168 is also included within the operating environment 100. The examined entity tracking system 168 tracks and monitors the identity of each entity such as a truck, car, train, boat, plain, cargo container, package, and the like, being examined. The tracking system 168 can include digital cameras, radio frequency identification tag (“RFID”) readers, bar code scanners, character recognition mechanisms, marking systems, and the like that allow the tracking system to identify an entity currently being examined. This allows the information processing system 144 and/or an operator to determine if an entity has previously been examined and to also flag an entity when hazardous materials potentially reside within the entity.

Mobile Environment Detection and Identification of Hazardous Material

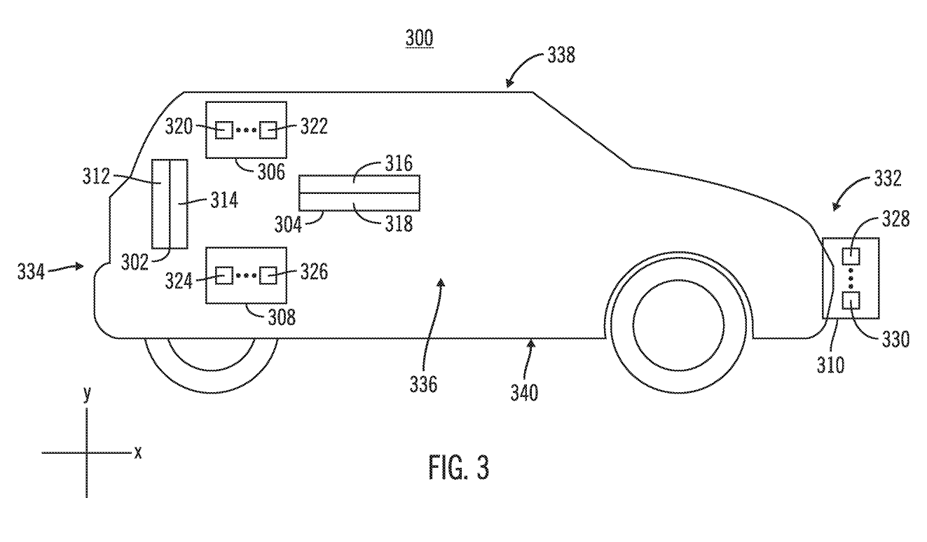

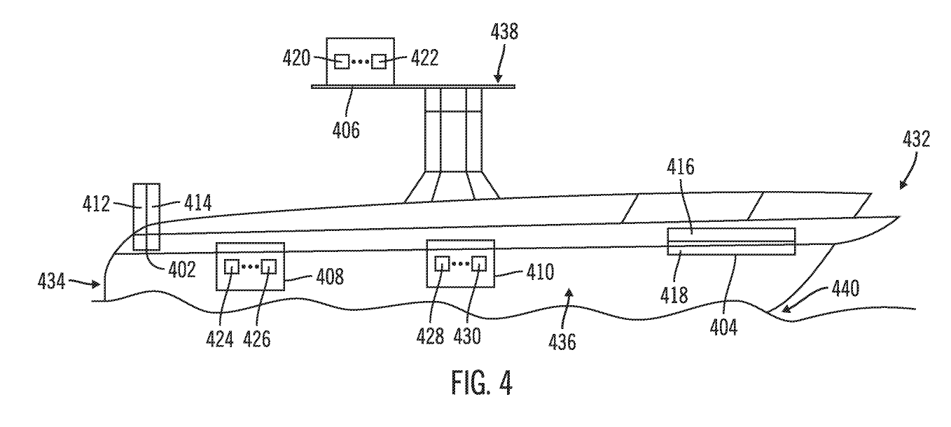

The following is a more detailed discussion on implementing the operating environment 100 (or at least a portion of the environment) discussed above with respect to FIG. 1 within a mobile environment such as a vehicle. FIGS. 3-4 show two examples of a mobile environment applicable to various embodiments of the present invention. For example, FIG. 3 shows a ground vehicle such as (but not limited) to a car or a truck, and FIG. 4 shows a marine vehicle such as (but not limited to) a boat. It should be noted that the mobile environments can be used as main radiation and identification systems, or as intercept vehicles, when a stand-off radiation system detects radiation emissions. For example, a stand-off radiation system can be situated at fixed locations for detecting radiation emissions at a distance. This system can then dispatch mobile units to intercept the source prior to the radiation source becoming a threat to an area protected by the stand-off radiation detection system.

In particular, FIG. 3 shows a mobile environment 300 such as a Sport Utility Vehicle comprising a plurality of sensor arrays 302, 304, 306, 308, 310. Each sensor array 302, 304, 306, 308, 310 includes one or more sets of sensors 312, 314, 316, 318, 320, 322, 324, 326, 328, 330. As discussed above, each sensor array 302, 304, 306, 308, 310 can include gamma sensors and/or neutron sensors. Additionally, one or more of the sensor arrays can also include a micro-neutron pulse device(s) 132 as well. In the example of FIG. 3 at least two of the sensor arrays 302, 304 are DDS arrays for detecting and determining the direction of a radiation source. As can be seen, each of the DDS arrays 302, 304 includes two sensors 312, 314, 316, 318 that are configured in the back-to back configuration discussed above. The DDS arrays 302, 304 are situated within the mobile environment 300 perpendicular to each other to provide a 360 degree detection zone.

Also, the mobile environment 300 of FIG. 3 includes at least one sensor array 306 comprising gamma sensors and at least one sensor array 308 comprising neutron sensors. In addition to the sensor arrays 302, 304, 306, 308, 310, the mobile operating environment 300, in one embodiment, also includes the remaining items discussed above with respect to FIG. 1 with the exception of the remote information processing system 162 and the user interface 164. Therefore, the mobile environment 300 can detect radiation and hazardous materials, determine the direction of radiation emission, and identify detected hazardous materials while the mobile environment 300 is travelling. However, it should be noted that one or more of the items in the operating environment of FIG. 1 can be situated at a location that is remote to the mobile operating environment 300.

In this embodiment, the mobile operating environment 300 accesses these remote items via one or more networks 130, 134. For example, the mobile operating environment 300 can include only the sensor arrays 302, 304, 306, 308, 310, a user interface 142, and networking equipment. As the sensor arrays 302, 304, 306, 308, 310 perform their operations, the data collected by the sensor arrays 302, 304, 306, 308 is transmitted over a network 130 so that the data analysis and monitoring manager 146 can perform data analysis operations such as radiation direction identification and hazardous material identification. The resulting information can be passed back to the mobile operating environment 300 via one of the networks 130, 134 and displayed to a user within the mobile operating environment via the user interface 130.

It should be noted that the locations of the sensor arrays 302, 304, 306, 308, 310 within the mobile environment 300 as shown in FIG. 3 are only one example, and do not limit the present invention in any way. For example, the sensor arrays 302, 304, 306, 308, 310 can be situated about a front portion 332, a rear portion 334, one or more side portions 336, a top portion 338, a bottom portion 340, and/or any portion therebetween, of the mobile operating environment 300.

FIG. 4 shows a marine mobile operating environment 400 such as a boat. The configuration of the mobile environment 400 in FIG. 4 is similar to the mobile environment 300 of FIG. 3. For example, the mobile environment 400 includes a plurality of sensor arrays 402, 404, 406, 408, 410. Each sensor array 402, 404, 406, 408, 410 includes one or more sets of sensors 412, 414, 416, 418, 420, 422, 424, 426, 428, 430. In the example of FIG. 4 at least two of the sensor arrays 402, 404 are configured as DDS arrays for detecting and determining the direction of a radiation source. As can be seen, each of the DDS arrays 402, 404 includes two sensors 412, 414, 416, 418 that are configured in the back-to back configuration discussed above. The DDS arrays 402, 404 are situated within the mobile environment 400 perpendicular to each other to provide a 360 degree detection zone.

Also, the mobile environment 400 of FIG. 4 includes at least one sensor array 406 comprising gamma sensors and at least one sensor array 408 comprising neutron sensors. In addition to the sensor arrays 402, 404, 406, 408, 410, the mobile operating environment 400, in one embodiment, also includes the remaining items discussed above with respect to FIG. 1 with the exception of the remote information processing system 162 and the user interface 164. Therefore, the mobile environment 400 can detect radiation and hazardous materials, determine the direction of radiation emission, and identify detected hazardous materials while the mobile environment 400 is travelling. For example, the mobile environment 400 can locate, detect, and identify radiological and fissile materials within other vessels, in waterways, or on the high seas. A communications capability allows the mobile environment 400 to report the findings and radiological data to another vessel and/or a land based operations center as needed.

It should be noted that the locations of the sensor arrays 402, 404, 406, 408, 410 within the mobile environment 400, as shown in FIG. 4, are only one example and do not limit the present invention in any way. For example, the sensor arrays 402, 404, 406, 408, 410 can be situated on a front portion 432, a rear portion 434, one or more side portions 436, a top portion 438, a bottom portion 440, and/or any portion therebetween, of the mobile operating environment 400.

By implementing the operating environment 100 (or at least a portion of the operating environment 100) within a mobile environment, a mobile system is created that is able to (1) determine the direction of a radiation source; (2) utilize gamma detectors for detecting and identifying any isotopes present within an entity/area being examined and/or approached by the mobile environment; (3) utilize neutron detectors for identifying the presence of fissile materials within an entity/area being examined and/or approached by the mobile environment; (4) perform optional long range radiation detection; (5) perform neutron pulse operations for detection of shielded fissile materials, explosives, and other materials of interest; and (6) optionally detect and identify chemical, biological, and materials within an entity/area being examined and/or approached.

Also, implementing the operating environment 100 within a mobile environment allows for much larger areas to be scanned than stationary or fixed systems. For example, a car/truck can drive around a city, airport, marine, sea port, and the like, and perform scanning operations. The DDS arrays determine the direction of a radiation source so operators within the car/truck, or remotely located operators, can determine the direction of travel needed to locate a radiation source.

In various embodiments of the present invention, a mobile environment, such as those examples discussed above with reference to FIGS. 3 and 4, an information processing system located in the moving vehicle can include a GPS positioning module (not shown) that identifies the GPS position of the moving vehicle. Mapping software, operating with the information processing system, can accurately track the position of the moving vehicle relative to a geographical map of a region. The position of the moving vehicle on the map of the region can be displayed to a user, such as by using graphic display software and a graphic display monitor coupled to the information processing system. Additionally, with the ability to determine the relative direction of a radiation source, the information processing system on the moving vehicle can capture two or more relative directions of the radiation source, i.e., relative to the moving vehicle. This then allows the information processing system to accurately calculate and track a specific radiation source location on the map. The information processing system, such as with tracking software, can triangulate the geographic location of the specific radiation source by using two relative directions of the radiation source coupled with two respective geographic locations of the vehicle (using the GPS position of the vehicle), determined as the moving vehicle moves in a geographic region. Therefore, the geographic location of the specific radiation source can be accurately determined. Additionally, this geographic location of the specific radiation source can be potted on a map of a geographic region, and optionally displayed to a user of the system. The location of the radiation source can be tracked whether the radiation source is stationary or moving. The movement of the radiation source can also be tracked and displayed on a map of the geographic region, i.e., using the graphic display software and a graphic display monitor coupled to the information processing system. The map is displayed to personnel that are using the tracking system. The map display mechanism can include a stationary map display, and/or a moving map display that advances a displayed map of a portion of a geographic region to display one or more portions of the map of the geographic region that may be relevant to the tracking system. For example, while the radiation source is moving in a geographic region, the graphic display software and the graphic display monitor can display the portion of the map of the region where the specific radiation source is located. As the radiation source moves in the geographic region, the moving map display advances (in response to the tracking software determining a new geographic location for the radiation source) and continuously displays the relevant portion of the map of the region where the specific radiation source is currently located.

In another embodiment, the mobile environments discussed above can be used in conjunction with stationary or fixed portals as well. For example, one or more of the sensor arrays 102, 104, 106, 108, 110, 112 can be deployed at strategic locations within a city, marina, port, airport, building, housing communities, waterway channels, on the sides of a waterway channel under a bridge, on the sides of a roadway under a bridge in stand-alone positions along the water channel or roadways, entranceways into harbors, at buoys, or the like for detecting radiation. These sensor arrays can then generate radiation alarms when radiation is detected. A mobile detection and identification system can then be dispatched to the area associated with the sensor array(s) that detected the radiation for further detection and analysis.

As discussed above, the sensor arrays 102, 104, 106, 108, 110, 112 scan an entity/area to be examined. Each of the gamma and/or neutron sensors generates signals indicative of any gamma and/or neutron radiation detected. As discussed above, this sensor data 142 is collected by the data collection manager 138 and stored within one or more data storage units 140. The data analysis and monitoring manager 146 then analyzes the data 142 to determine if any hazardous materials have been detected and/or the direction of where a radiation source is located.

For example, the data analysis and monitoring manager 146 includes a multi-channel analyzer (“MCA”) 148 comprising one or more devices, a device composed of multiple single channel analyzers (“SCA”). In one embodiment, the MCA 148, uses analog to digital converters combined with computer memory that is equivalent to thousands of SCAs and counters and is dramatically more powerful and cost efficient than individual SCAs. The SCA interrogates analog signals received from the individual radiation sensors 114, 116, and determines whether the specific energy range of the received signal is equal to the range identified by the single channel. If the energy received is within the SCA, an SCA counter is updated. Over time, the SCA counts are accumulated. At a given time interval, a multi-channel analyzer 148 includes a number of SCA counts, which result in the creation of at least one histogram 170.

The histogram 170 represents the spectral image of the radiation that is present within the entity/area being examined. In other words, the histogram 170 is a fingerprint of the entity being examined. The histogram 170 can represent a portion of the entity or the entire entity. In one embodiment, a single histogram 170 can be created based on information received from all of the sensor arrays 102, 104, 106, 108, 110, 112. In another embodiment, a single histogram 170 can be created from the combination of one or more histograms associated with one or more sensors 114, 116 in the sensor arrays 102, 104, 106, 108, 110, 112. In yet another embodiment, a histogram 170 can be created for each sensor 114, 116 within the sensor arrays 102, 104, 106, 108, 110, 112. A more detailed discussion on histograms is given in U.S. Pat. No. 7,142,109 entitled “Container Verification System For Non-Invasive Detection Of Contents”, filed on Feb. 27, 2006; and U.S. Pre-Grant Publication 2008/0048872 entitled, “Multi-Stage System For Verification Of Container Contents”, filed on Oct. 31, 2007, which are both commonly owned and hereby incorporated by reference in their entireties.

The histogram 170 is used by the spectral analyzer 150 to identify isotopes that are present in materials residing within in the entity/area under examination. One of the functions performed by the data and analysis manager 146 is spectral analysis, performed by the spectral analyzer 138, to identify the one or more isotopes, explosives or special materials residing within the entity/area under examination. With respect to radiation detection, the spectral analyzer 150 compares one or more spectral images (e.g., represented by histograms 170, and/or by other collections of data associated with the sensors) of the radiation that has been detected within the entity/area to known isotopes that are represented by one or more spectral images stored 160 in the materials database 156. By capturing multiple variations of spectral data for each isotope there are numerous images that can be compared to one or more spectral images of the radiation present.

The materials database 156, according to one embodiment, holds one or more spectral images 160 of each isotope to be identified. These multiple spectral images represent various levels of acquisition of spectral radiation data so isotopes can be compared and identified using various amounts of spectral data available from the one or more sensors. Whether there are small amounts or large amounts of data acquired from the sensors, the spectral analyzer 150 compares the acquired radiation data from the one or more sensors 114, 116 to one or more spectral images 160 for each isotope to be identified. This significantly enhances the reliability and efficiency of matching acquired spectral image data from the one or more sensors to spectral image data of each possible isotope to be identified.

Once one or more possible isotopes are determined to be present in the radiation detected by the sensor(s) 114, 116 the data analysis and monitoring manager 146 compares the determined set of isotopes against possible materials, goods, and/or products that may be present in the entity/area under examination. The manifest database 154 includes a detailed description 156 of the contents of each entity/area that is to be examined. The manifest 156 can be referred to by the data analysis and monitoring manager 146 to determine whether the possible materials, goods, and/or products, contained in the entity/area match the expected authorized materials, goods, and/or products, described in the manifest 156 for the particular entity/area under examination. This matching process, according to one embodiment of the present invention, is significantly more efficient and reliable than any container contents monitoring process in the past.

It should be noted that the spectral analyzer 150 is able to utilize various methods to provide multi-confirmation of the isotopes identified. Should more than one isotope be present, the spectral analyzer 150 identifies the ratio of each isotope present. Examples of methods that can be used for spectral analysis such as that discussed above include: 1) a margin setting method as described in U.S. Pat. No. 6,847,731 entitled “Method And System For Improving Pattern Recognition System Performance”, filed Aug. 7, 2000, which is hereby incorporated by reference in its entirety; and 2) a LINSCAN method (a linear analysis of spectra method) as discussed in U.S. Provisional patent application Ser. No. 11/624,067, filed on Jan. 17, 2006, by inventor David L. Frank, and entitled “Method For Determination Of Constituents Present From Radiation Spectra And, If Available, Neutron And Alphas Occurrences”; the collective entire teachings of which being herein incorporated by reference.

With respect to analysis of collected data pertaining to explosives and/or special materials, the spectral analyzer 150 and compares identified possible explosives and/or special materials to the manifest 160 by converting the stored manifest data 160 relating to the entity/area under examination to expected explosives and/or radiological materials and then by comparing the identified possible explosives and/or special materials with the expected explosives and/or radiological materials. If the system 146 determines that there is no match to the manifest 160 for the entity/area then the identified possible explosives and/or special materials are unauthorized. The system 146 can then provide information to system supervisory personnel to alert them to the alarm condition and to take appropriate action. For example, the user interface 152, 164 can present to a user a representation of the collected received returning signals, or the identified possible explosives and/or special materials in the entity/area under examination, or any system identified unauthorized explosives and/or special materials contained within the entity/area under examination, or any combination thereof.

A more detailed discussion on spectral analysis is given in U.S. Pat. No. 7,142,109 entitled “Container Verification System for Non-Invasive Detection of Contents”, filed on Feb. 27, 2006; and U.S. Pre-Grant Publication 2008/0048872 entitled, “Multi-Stage System For Verification Of Container Contents”, filed on Oct. 31, 2007, which are collectively commonly owned and hereby incorporated by reference in their entirety.

In addition to gamma and neutron sensors, neutron pulse devices 132 can also be deployed within the operating environment 100 as discussed above. The neutron pulse devices 132 include coincident counting capabilities. The gamma detectors within the neutron pulse device are used to identify chemical and explosives materials from the gamma response to the neutron pulse. A more detailed discussion on using micro-neutron pulse device is provided in the provisional U.S. Patent Application No. 61/128,115, entitled “Mobile Frame Structure With Passive/Active Sensor Arrays For Non-Invasive Analysis For CBRNE Materials Present”, filed on May 19, 2008, by the same inventor as the present application, and which is hereby incorporated by reference in its entirety.

Various embodiments discussed above are advantageous because the sensor array configurations on mobile environments can yield greater scan times, which allows for spectral analysis and hazardous material identification with respect to an object being examined. Therefore, the sensor array configurations as discussed above enable the scanning entity, such as the mobile environment, to quickly and effectively operate for a system to analyze the object and/or area of interest, thereby enabling identification of hazardous materials within the entity and/or area of interest, even while remotely located.

Example of a Process for Radiation Detection and Identification Using a Mobile System

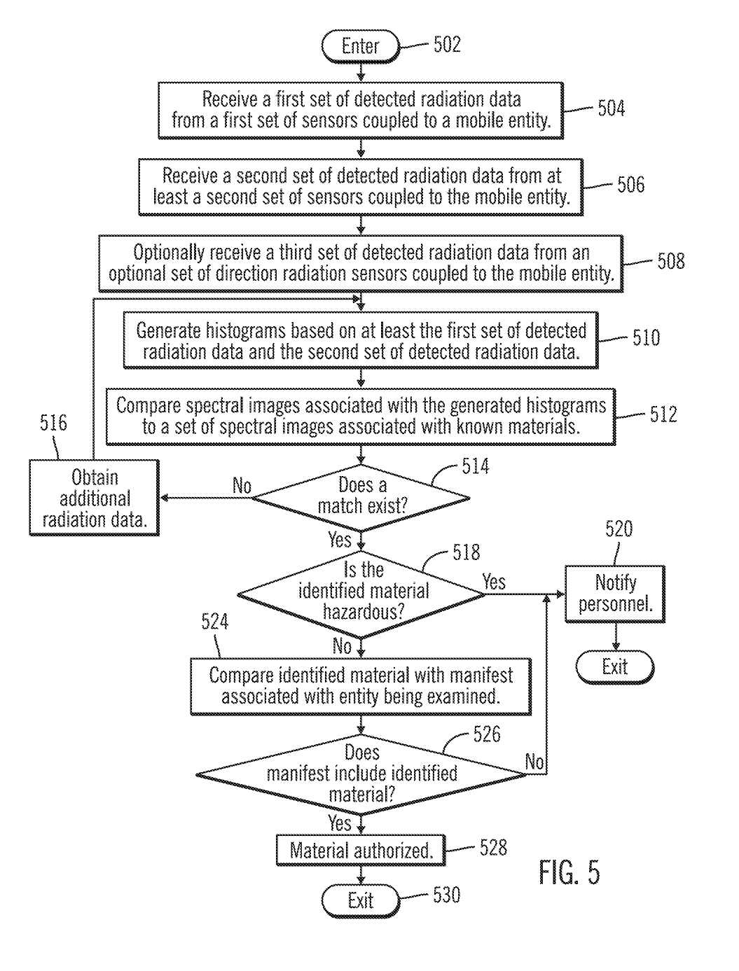

FIG. 5 is an operational flow diagram illustrating one process of detecting radiation and identifying hazardous materials associated with the radiation using a mobile environment such as a car, truck, boat, helicopter, and the like. The operational flow diagram starts at step 502 and flows directly into step 504. The data analysis and monitoring manager 146, at step 504, receives a first set of detected radiation data from a first set of sensors 306 that are mechanically coupled to the mobile entity 300. The manager 146, at step 506, receives a second set of detected radiation data from at least a second set of sensors 308 that are mechanically coupled to the mobile entity 300. For example, the manager 146 can receive gamma (and/or neutron) counts and associated energy counts detected by the sensor arrays 306, 308. It should be noted that neutron pulse information can also be provided to the manager 146 as well.

The manager 146, at step 508, optionally receives a third set of detected radiation data from an optional set of direction radiation sensors 302 (and/or 304) that are mechanically coupled to the mobile entity 300. As discussed above, this third set of detected radiation data enables the manager 146 to determine the direction from which the radiation is being emanated. It should be noted that the detectors sets 302 (and/or 304), 306, 308 can perform their detection operations while the mobile entity is moving and/or stationary.

The manager 146, at step 510, generates one or more histograms 170 based on at least the first set of detected radiation data and the second set of detected radiation data, as discussed above. The manager 146, at step 512, compares spectral images associated with the generated histograms to a set of spectral images 156 associated with known materials. The manager 146, at step 514, determines if a match exists between the spectral images associated with the generated histograms 170 and the set of spectral images 156 associated with known materials. If the result of this negative is negative, the manager 146, at step 516, obtains additional radiation data from the sensors 306, 308 (and/or 302/304) and the control flow returns to step 510. If the result of this determination is positive, the manager 146, at step 518, determines if the material identified by the comparison is hazardous. If the result of this determination is positive, the manager 146, at step 520, notifies personnel. The control flow then exits at step 522.

If the result of this determination is negative, the manager 146, at step 524, compares the identified material with a manifest 158 associated with the entity being examined. The manager 146, at step 526, determines if the manifest includes the identified material. If the result of this determination is negative, the identified material is unauthorized and the manager 146, at step 520, notifies personnel. The control flow then exits at step 522. If the result of this determination is positive, the manager 146, at step 528, determines that the identified material is authorized and the control flow then exits at step 530.

Information Processing System

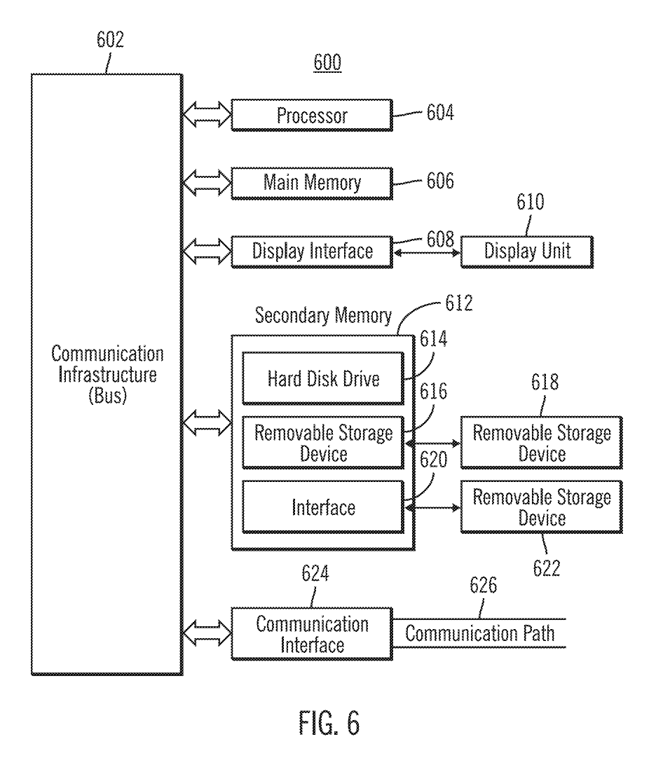

FIG. 6 is a high level block diagram illustrating a more detailed view of a computing system 600 such as the information processing system 144 useful for implementing the data and analysis manager 146 according to various embodiments of the present invention. The computing system 600 is based upon a suitably configured processing system adapted to implement an embodiment of the present invention. For example, a personal computer, workstation, or the like, may be used.

In one embodiment of the present invention, the computing system 600 includes one or more processors, such as processor 604. The processor 604 is connected to a communication infrastructure 602 (e.g., a communications bus, crossover bar, or network). Various software embodiments are described in terms of this exemplary computer system. After reading this description, it should become apparent to a person of ordinary skill in the relevant art(s) how to implement an embodiment of the present invention using other computer systems and/or computer architectures.

The computing system 600 can include a display interface 608 that forwards graphics, text, and other data from the communication infrastructure 602 (or from a frame buffer) for display on the display unit 610. The computing system 600 also includes a main memory 606, preferably random access memory (RAM), and may also include a secondary memory 612 as well as various caches and auxiliary memory as are normally found in computer systems. The secondary memory 612 may include, for example, a hard disk drive 614 and/or a removable storage drive 616, representing a floppy disk drive, a magnetic tape drive, an optical disk drive, and the like. The removable storage drive 616 reads from and/or writes to a removable storage unit 618 in a manner well known to those having ordinary skill in the art.

Removable storage unit 618, represents a floppy disk, a compact disc, magnetic tape, optical disk, etc. which is read by and written to by removable storage drive 616. As are appreciated, the removable storage unit 618 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 612 may include other similar means for allowing computer programs or other instructions to be loaded into the computing system 600. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computing system 600.

The computing system 600, in this example, includes a communications interface 624 that acts as an input and output and allows software and data to be transferred between the computing system 600 and external devices or access points via a communications path 626. Examples of communications interface 624 may include a modem, a network interface (such as an Ethernet card), a communications port, a PCMCIA slot and card, etc. Software and data transferred via communications interface 626 are in the form of signals which may be, for example, electronic, electromagnetic, optical, or other signals capable of being received by communications interface 624. The signals are provided to communications interface 624 via a communications path (i.e., channel) 626. The channel 626 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 606 and secondary memory 612, removable storage drive 616, and a hard disk installed in hard disk drive 614. The computer program products are means for providing software to the computer system. The computer readable medium allows the computer system to read data, instructions, messages or message packets, and other computer readable information from the computer readable medium.

Computer programs (also called computer control logic) are stored in main memory 606 and/or secondary memory 612. Computer programs may also be received via communications interface 624. Such computer programs, when executed, enable the computer system to perform the features of the various embodiments of the present invention as discussed herein. In particular, the computer programs, when executed, enable the processor 604 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method, with an information processing system on a mobile vehicle, for detecting radiation and identifying materials associated with radiation that has been detected, the method comprising:
receiving from a set of radiation sensors mechanically coupled to the mobile vehicle, a set of radiation data associated with at least one radiation source;
generating at least one histogram based on the received set of radiation data, wherein the at least one histogram represents a spectral image of the radiation from the radiation source;
comparing the at least one histogram to a plurality of spectral images associated with known materials;
determining that the at least one histogram substantially matches at least one of the plurality of spectral images;
determining if a material associated with the at least one of the plurality of spectral images is a hazardous material; and
notifying personnel that the at least one radiation source is a hazardous material in response to determining that the material associated with the at least one of the plurality of spectral images is a hazardous material.

2. The method of claim 1, wherein the set of radiation data is received while the mobile vehicle is moving.

3. The method of claim 1, further comprising:
receiving from at least one additional set of radiation sensors comprising a first radiation sensor and a second radiation sensor mechanically coupled to the mobile vehicle, at least one additional set of radiation data associated with the at least one radiation source.

4. The method of claim 3, wherein a body portion of the first radiation sensor is mechanically coupled in close proximity to a body portion of the second radiation sensor so that the first radiation sensor and the second radiation sensor are adjacent to each other, and wherein a sensing portion of the first radiation sensor and a sensing portion of the second radiation sensor are adjacent in close proximity with each other, and wherein the method further includes
determining a direction of the at least one radiation source, relative to the first radiation sensor and the second radiation sensor, from the received at least one additional set of radiation data associated with the at least one radiation source.

5. The method of claim 3, further comprising:
comparing radiation energy count associated with the first radiation sensor to a radiation energy count associated with the second radiation sensor;
determining that one of the first radiation sensor and the second radiation sensor has detected a larger radiation energy count and the other has detected a lower radiation energy count; and
determining, based on the determining of the larger and lower radiation energy counts, that the at least one radiation source is in a direction that is substantially from the one of the first radiation sensor and the second radiation sensor that has detected the lower radiation energy count to the other one that has detected the larger radiation energy count.

6. The method of claim 5, further comprising:
directing the mobile vehicle towards the direction that has been determined.

7. The method of claim 3, further comprising:
comparing a relative timing relationship between a radiation energy count associated with the first radiation sensor and a radiation energy count associated with the second radiation sensor;
determining an earlier time of a traveling gamma or neutron particle entering one of the first radiation sensor and the second radiation sensor and a later time entering the other one; and
determining, based on the determining of the earlier time, that the at least one radiation source is in a direction that is substantially from one of the first radiation sensor and the second radiation sensor that has detected the later time to the other one that has detected the earlier time.

8. The method of claim 1, further comprising;
determining that the material associated with the at least one of the plurality of spectral images fails to be a hazardous material;
comparing the material with at least one manifest associated with an entity comprising the radiation source;
determining if the material substantially matches at least one item on the at least one manifest; and
notifying personnel that the entity comprises at least one unauthorized item in response to determining that the material fails to substantially match at least one item on the at least one manifest.

9. A mobile vehicle for detecting radiation and identifying materials associated with radiation that has been detected, the mobile vehicle comprising:
at least one set of radiation sensors mechanically coupled to a portion of the mobile vehicle;
at least one information processing system communicatively coupled to the set of radiation sensors, wherein the information processing system is adapted to:
receive from the at least one set of radiation sensors mechanically coupled to the mobile vehicle, a set of radiation data associated with at least one radiation source;
generate at least one histogram based on the set of radiation data, wherein the at least one histogram represents a spectral image of the radiation source;
compare the at least one histogram to a plurality of spectral images associated with known materials;
determine that the at least one histogram substantially match at least one of the plurality of spectral images;
determine if a material associated with the at least one of the plurality of spectral images is a hazardous material; and
notify personnel that the at least one radiation source is a hazardous material in response to determining that the material associated with the at least one of the plurality of spectral images is a hazardous material.

10. The mobile vehicle of claim 9, wherein the set of radiation data is received while the mobile vehicle is moving.

11. The mobile vehicle of claim 9, further comprising:
at least one additional set of radiation sensors comprising a first radiation sensor and a second radiation sensor mechanically coupled to a portion of the mobile vehicle, wherein the at least one information processing system is further adapted to:
receive at least one additional set of radiation data associated with the at least one radiation source from the at least one additional set of radiation sensors.

12. The mobile vehicle of claim 11, wherein a body portion of the first radiation sensor is mechanically coupled to a body portion of the second radiation sensor so that the first radiation sensor and the second radiation sensor are adjacent to each other, and wherein a sensing portion of the first radiation sensor and a sensing portion of the second radiation sensor face opposite directions.

13. The mobile vehicle of claim 11, wherein the at least one information processing system is further adapted to:
comparing radiation energy count associated with the first radiation sensor to a radiation energy count associated with the second radiation sensor;
determining that one or the first radiation sensor and the second radiation sensor has detected a larger radiation energy count; and
determining, based on the determining, that the at least one radiation source is in a direction that is substantially identical to a direction in which the one of the first radiation sensor and the second radiation sensor that has detected the larger radiation energy count is facing.

14. The mobile vehicle of claim 9, wherein the at least one information processing system is further adapted to;
determine that the material associated with the at least one of the plurality of spectral images fails to be a hazardous material;
compare the material with at least one manifest associated with an entity comprising the radiation source;
determine if the material substantially matches at least one item on the at least one manifest; and
notify personnel that the entity comprises at least one unauthorized item in response to determining that the material fails to substantially match at least one item on the at least one manifest.

15. A system for detecting radiation and identifying materials associated with radiation that has been detected, the system vehicle comprising:
at least one mobile vehicle comprising at least one set of radiation sensors mechanically coupled to a portion of the mobile vehicle;
at least one information processing system communicatively coupled to the at least one mobile vehicle, wherein the information processing system is adapted to:
receive from the at least one set of radiation sensors a set of radiation data associated with at least one radiation source;
generate at least one histogram based on the set of radiation data, wherein the at least one histogram represents a spectral image of the radiation source;
compare the at least one histogram to a plurality of spectral images associated with known materials;
determine that the at least one histogram substantially match at least one of the plurality of spectral images;
determine if a material associated with the at least one of the plurality of spectral images is a hazardous material; and
notify personnel that the at least one radiation source is a hazardous material in response to determining that the material associated with the at least one of the plurality of spectral images is a hazardous material.

16. The system of claim 15, wherein the at least one set of radiation sensors and the information processing system being adapted to receive the set of radiation data from the at least one set of radiation sensors while the mobile vehicle is moving.

17. The system of claim 15, wherein the mobile vehicle further comprises:
at least one additional set of radiation sensors comprising a first radiation sensor and a second radiation sensor, mechanically coupled to a portion of the mobile vehicle, and, wherein the at least one information processing system is further adapted to:
receive at least one additional set of radiation data associated with the at least one radiation source from the at least one additional set of radiation sensors; and
determine a direction of the at least one radiation source, relative to the first radiation sensor and the second radiation sensor, from the received at least one additional set of radiation data associated with the at least one radiation source.

18. The system of claim 17, wherein a body portion of the first radiation sensor is mechanically coupled to a body portion of the second radiation sensor so that the first radiation sensor and the second radiation sensor are adjacent to each other, and wherein a sensing portion of the first radiation sensor and a sensing portion of the second radiation sensor face opposite directions.

19. The system of claim 17, wherein the information processing system is further adapted to:
compare radiation energy count associated with the first radiation sensor to a radiation energy count associated with the second radiation sensor;
determine that one of the first radiation sensor and the second radiation sensor has detected a larger radiation energy count and the other has detected a lower radiation energy count; and
determine, based on the determining of the larger and lower radiation energy counts, that the at least one radiation source is in a direction that is substantially identical to a direction in which the one of the first radiation sensor and the second radiation sensor that has detected the larger radiation energy count is facing.

20. The system of claim 15, wherein the at least one information processing system is further adapted to;
determine that the material associated with the at least one of the plurality of spectral images fails to be a hazardous material;
compare the material with at least one manifest associated with an entity comprising the radiation source;
determine if the material substantially matches at least one item on the at least one manifest; and
notify personnel that the entity comprises at least one unauthorized item in response to determining that the material fails to substantially match at least one item on the at least one manifest.
